(19) United States
(12) Patent Application Publication
(10) Pub. No.: US 2003/0078837 A1
(43) Pub. Date: Apr. 24, 2003

(54) Method for providing advertisement related to specific content contained on a digital disc on the disc

(75) Inventors: Yawcheng Lo, Rochester, NY (US); Alexander C. Loui, Penfield, NY (US); Thomas M. Stephany, Churchville, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/981,830

(22) Filed: Oct. 18, 2001

(51) Int. Cl. G06F 17/60

(52) U.S. Cl. 705/14

(57) ABSTRACT

A method for providing specific subject-related advertisement on a digital disc, which advertisement is related to specific content on the digital disc, the method comprises the steps of extracting information from the content; correlating the extracted information to pre-determined advertisements; and placing the correlated advertisement on the disc for providing the specific subject-related advertisement to a user.

### FIELD OF THE INVENTION

The invention relates generally to the field of digital media which stores and displays images and, more particularly, to placing advertisements on the digital media according to extracted informational content from the images.

### BACKGROUND OF THE INVENTION

Transferring images to another type of media is currently in common usage. For example, images captured by conventional photography are converted to digital images and stored on some type of media for later use. The transfer of images does not currently include analyzing and understanding the image content for purposes other than producing more pleasing images. This transfer presents an opportunity for adding value for the consumer.

Although the presently known and utilized method of transferring images is satisfactory, there is an opportunity for adding additional value.

Consequently, a need exists for including additional value during the transfer of digital images.

### SUMMARY OF THE INVENTION

The present invention is directed to overcoming one or more of the problems set forth above. Briefly summarized, according to one aspect of the present invention, the invention relates to a method for providing specific subject-related advertisement on a digital disc, which advertisement is related to specific content on the digital disc, the method comprising the steps of (a) extracting information from the content; (b) correlating the extracted information to pre-determined advertisements; and (c) placing the correlated advertisement on the disc for providing the specific subject-related advertisement to a user.

These and other aspects, objects, features and advantages of the present invention will be more clearly understood and appreciated from a review of the following detailed description of the preferred embodiments and appended claims, and by reference to the accompanying drawings.

Advantageous Effect of the Invention

The present invention has the following advantage of analyzing the image content during image transfer and including advertisements, based on this analysis, to the media to which the images are transferred.. Advanced image analysis and understanding algorithms are used to detect and classify event in images. These will include the use of image-based techniques such as face detection, face recognition, people detection, and event segmentation and classification. The present invention will also utilize available meta-data information such as date/time of capture, and location of capture to aid in content understanding and detection of specific event such as Christmas celebration, or a vacation trip to Paris and the like.

### BRIEF DESCRIPTION OF THE DRAWINGS

FIG. 1 is a perspective view of a kiosk for implementing the present invention; and

FIG. 2 is a flowchart of a software program of the present invention implemented on the kiosk.

### DETAILED DESCRIPTION OF THE INVENTION

In the following description, a portion of the present invention will be described in the preferred embodiment as a software program. Those skilled in the art will readily recognize that the equivalent of such software may also be constructed in hardware.

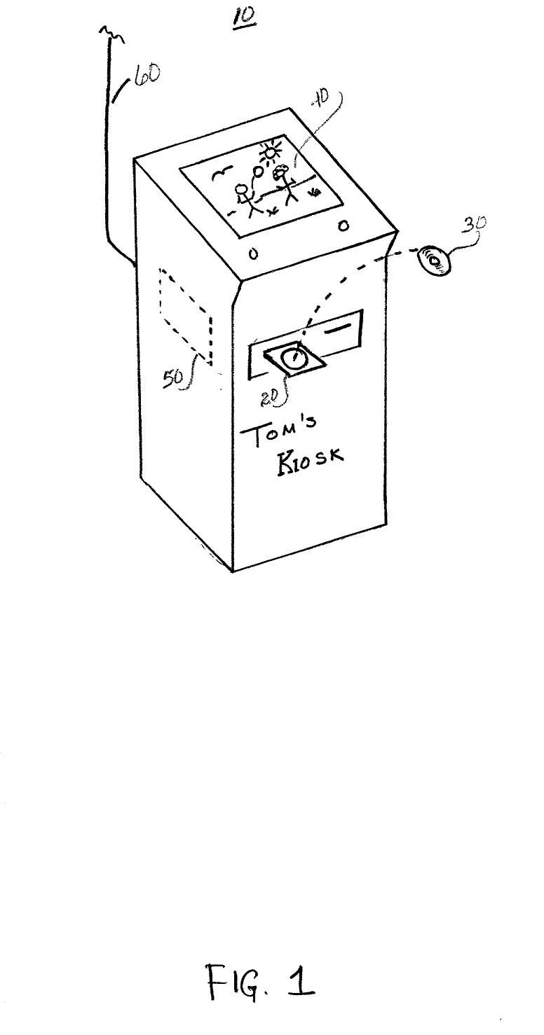

Referring to FIG. 1, there is shown a kiosk 10 of the present invention. While kiosk 10 is used in the preferred embodiment, it should be understood that there are a variety of alternative apparatuses and/or methods where this could be also accomplished. For example, such information could be extracted during traditional analog photo processing, wherein advertising could be supplied along with the customers processed photos. The kiosk 10 includes a platform 20 for receiving a disk 30 containing digital images. These images also could be supplied via a memory card or other similar user-supplied medium in which case other electronic components would be used to supply the images to the kiosk, such as analog image and flatbed scanners, all of which are well known in the art. The kiosk 10 includes a screen 40 for permitting viewing of the user images for the purpose of re-formatting the images onto a Video CD, DVD or other viable storage format. A microprocessor 50 is disposed within the kiosk 10 for executing software resident in the kiosk 10.

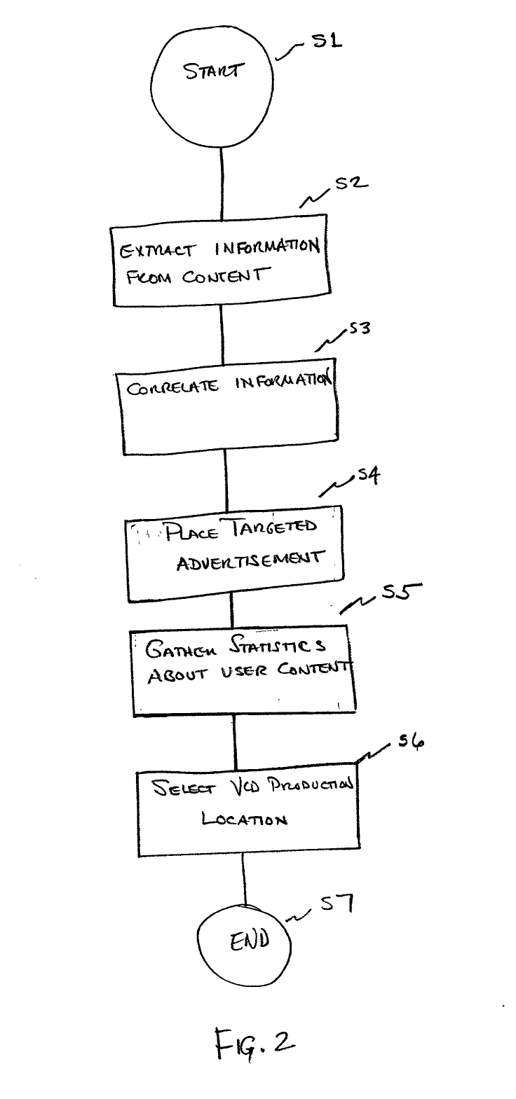

Referring to FIG. 2, the user places the disc 30 onto the platform 20 and inserts it into the kiosk 10 for initiating S1 the software. The kiosk 10 includes software that extracts and analyzes information S2 content from the digital images. For example, typical extracted content could be subjects or information, which would be of interest to advertisers. Such typical areas of customer interest are sporting events, rafting trips, special events or significant vacation spots. The software includes, but is not limited to, extracting text, facial recognition, event, date/time, and/or place all of which may be used for categorizing the image into one or more of the areas of specific interest. Such text, facial recognition, event, date/time, and/or place extraction software and algorithms are available for licensing from the Eastman Kodak Company and will not be discussed in detail herein.

The software correlates S3 the extracted area of interest to a plurality of stored advertisements, which have been pre-sorted to correspond to one or more areas of interest. The software then S4 places the corresponding advertisement (in the form of images, video, audio, or any combination) onto the disc by any well-known, suitable means. Additionally, advertisements could be supplied as pre-printed inserts or as print on demand advertisements, which could be daily updated by the sponsor of the content. The software also gathers S5 information about the user, such as number of hits on a specific area of interest and the like, for later use in determining appropriate advertisement. The software then prompts, via the screen 40, the user to select a location for production of the Video CD, DVD or other viable storage format, via link 60 referred to in FIG. 1. Link 60 could be any type of link including an Internet connection that connects kiosk 10 to a production location removed from kiosk 10. The software is then terminated S7.

The invention has been described with reference to a preferred embodiment. However, it will be appreciated that variations and modifications can be effected by a person of ordinary skill in the art without departing from the scope of the invention.

### Parts List

10 kiosk

20 platform

30 disc

40 screen

50 microprocessor

60 link

S1 step

S2 step

S3 step

S4 step

S5 step

S6 step

S7 step

What is claimed is:

1. A method for providing specific subject-related advertisement on a digital disc, which advertisement is related to specific content on the digital disc, the method comprising the steps of:
(a) extracting information from the content;
(b) correlating the extracted information to pre-determined advertisements; and
(c) placing the correlated advertisement on the disc for providing the specific subject-related advertisement to a user.

2. The method as in claim 1, wherein step (a) includes extracting either individually or in combination metadata, text, facial recognition, event, or date/time and/or place.

3. The method as in claim 1, wherein step (b) includes:
(b1) correlating the extracted information to either products, services, or employment and/or membership opportunities.

4. The method as in claim 3, wherein step (c) includes placing the information related to either products, services, or employment and/or membership opportunities on the disc.

5. The method as in claim 1 further comprising the step of extracting information related to use of an electronic device.
